(19) United States
(12) Patent Application Publication
(10) Pub. No.: US 2004/0078519 A1
(43) Pub. Date: Apr. 22, 2004

(54) Data reorganization method in a RAID striping system

(76) Inventors: Yuhyeon Bak, Daejeon (KR); Chang-Soo Kim, Daejeon (KR); Dong Jae Kang, Daejeon (KR); Young Ho Kim, Daejeon (KR)

Correspondence Address: JACOBSON HOLMAN PLLC, 400 SEVENTH STREET N.W., SUITE 600, WASHINGTON, DC, 20004, US

(21) Appl. No.: 10/645,626

(22) Filed: Aug. 22, 2003

(30) Foreign Application Priority Data
Oct. 17, 2002 (KR) 10-2002-63495

(51) Int. Cl. G06F 12/00

(52) U.S. Cl. 711/114

(57) ABSTRACT

There is provided a method for reorganizing data in a RAID system using a striping technique. First, it is determined whether an additional disk exists in a storage medium in the system. Then, it is checked whether a data is stored at a reorganization-requested location for a disk write operation reorganization-requested data to the reorganization request location if there exists the additional disk. Thereafter, a if no data is stored in the reorganization-requested location.

### FIELD OF THE INVENTION

The present invention relates to a data reorganization method in a redundant array of inexpensive (or independent) disks (RAID) system; and, more particularly, to a data reorganization method in a RAID system employing a striping technique to store data, thereby improving an input/output efficiency of a disk.

### BACKGROUND OF THE INVENTION

As the use of Internet is widespread, the work environment has been rapidly changed and the amount of data to be stored has been explosively increased. Further, the development of multi media has increased a data size to be processed by a general computer and a data capacity to be processed has also been increased due to the rise in the number of computer users.

However, general data storage systems, such as a data management system in a client server for storing and managing data by being connected to a single server and a network file system based on a file server, exhibit limitations in processing the data amount being in a great increase.

Thus, in recent years, a Redundant Array of Independent Disks (RAID) system has been employed in a data storage system in order to efficiently process the increased data. The technical concept of the RAID system is to maximize a maximum data transmission bandwidth by replacing one large drive with a plurality of small drives and utilizing all of their input/output bandwidths simultaneously.

The RAID technology provides various steps depending on its characteristics. RAID levels 0, 3, 4 and 5 relate to a method for distributing data into devices constructing a disk array and storing the data therein. Since the RAID system employs a striping technique where the data is sequentially written in each disk on a striping unit basis, an input and an output (I/O) process to/from each disk can be performed at the same time and, therefore, a parallel property can be improved.

In case a new disk is added to increase the disk capacity in the system in which the data is stored with the striping technique, a series of data reorganization processes should be performed.

FIGS. 1 and 2 describe such a data reorganization process. FIG. 1 shows a disk state before a new disk is added while FIG. 2 illustrates a disk state after the new disk is added.

The conventional data reorganization process, however, has drawbacks in that the operation of the system should be ceased during the reorganization process to read all the contents of the disk and store the data again according to an array format. Further, a general disk I/O operation cannot be conducted during another disk operation.

Accordingly, the conventional data reorganization process has a critical defect that a disk operation for the data reorganization is excessively time-consuming and, therefore, the system efficiency is deteriorated due to an accompanying overhead problem.

### SUMMARY OF THE INVENTION

It is, therefore, an object of the present invention to provide a data reorganization method in a RAID system using a striping technique for performing a reorganization process only for a data for which a write operation has been performed among a user request without reorganizing the whole data stored in an existing disk when a new disk is added for the purpose of expanding a system capacity, thereby enabling to provide a service immediately after the new disk is added.

In accordance with the present invention, there is provided a data reorganization method in a RAID system using a striping technique, the method including the steps of: (a) determining whether an additional disk exists in a storage medium of the system; (b) checking whether there exists any data stored at a reorganization-requested location for a disk write operation if there exists the additional disk; and (c) moving a reorganization-requested data to the reorganization request location if there is no data stored in the reorganization-requested location.

### BRIEF DESCRIPTION OF THE DRAWINGS

The above and other objects and features of the present invention will become apparent from the following description of preferred embodiments given in conjunction with the accompanying drawings, in which:

FIG. 1 shows a disk state before data reorganization is performed in a conventional RAID system;

FIG. 2 illustrates a disk state after data reorganization is performed in the conventional RAID system;

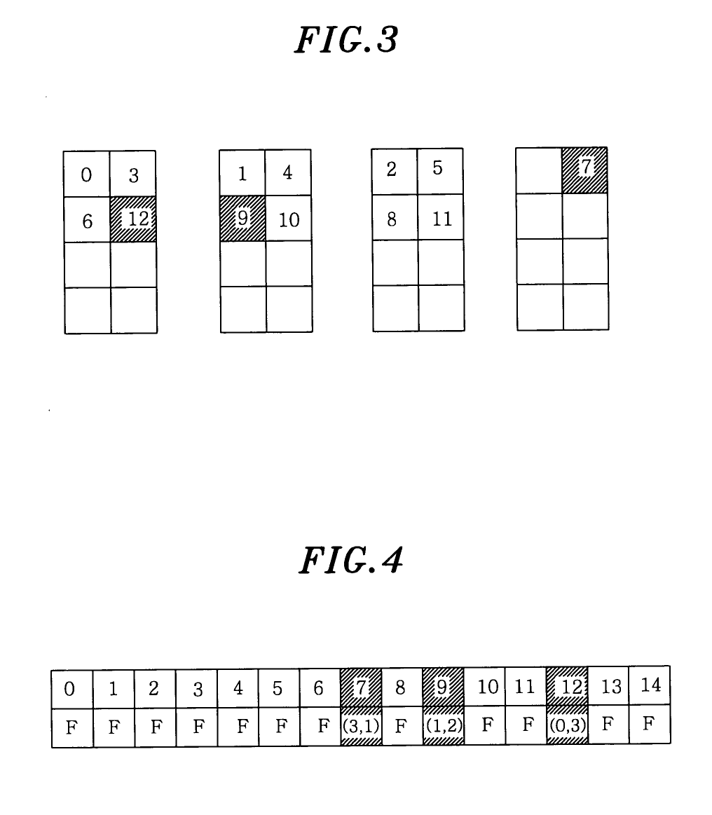

FIG. 3 describes a disk state after data reorganization is conducted for a block for which a write operation is requested in accordance with the present invention;

FIG. 4 explains a reorganization table state being changed during the block reorganization process shown in FIG. 3; and

FIG. 5 depicts a flowchart of a data reorganization process in a RAID system using a striping technique in accordance with a preferred embodiment of the present invention.

### DETAILED DESCRIPTION OF THE PREFERRED EMBODIMENTS

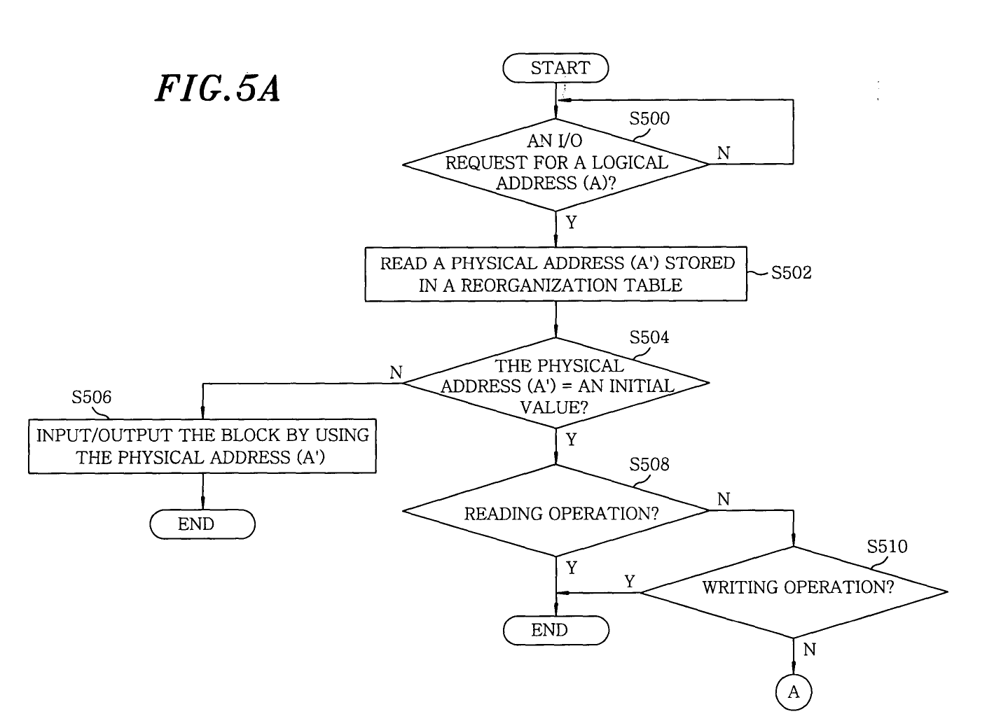

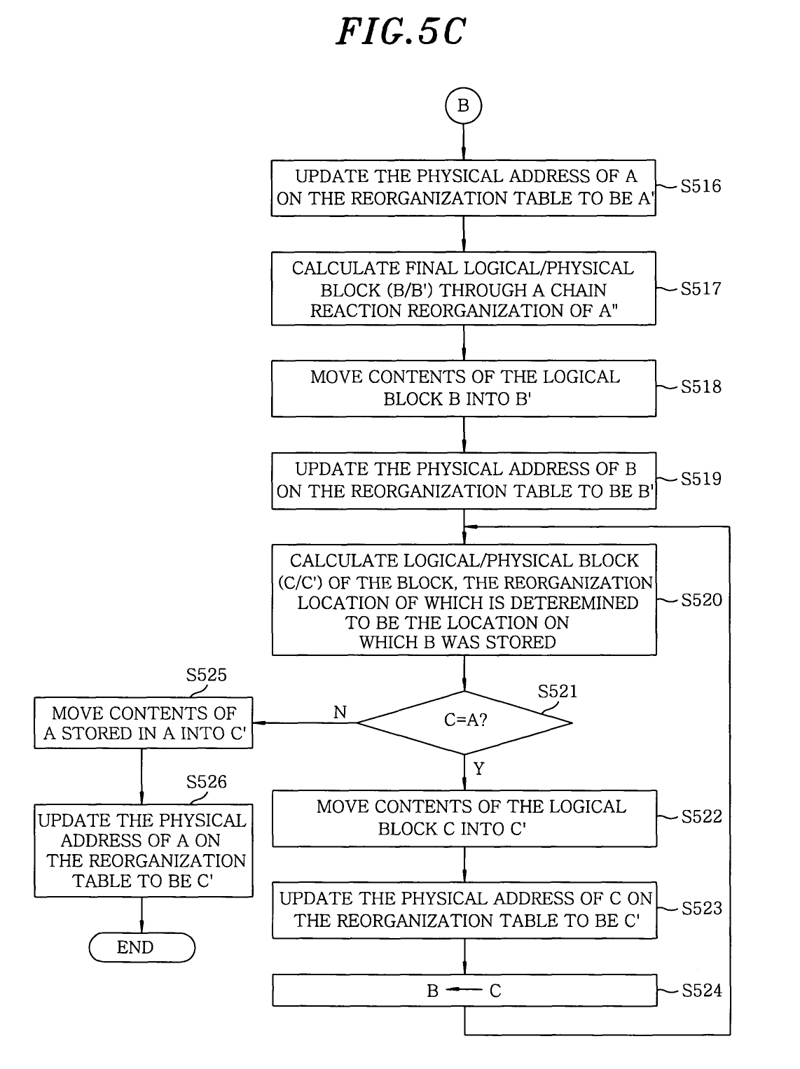

Referring to FIG. 3, there is illustrated a disk state after a data reorganization process is performed for a block for which a write operation is requested in accordance with the present invention. FIG. 5 provides a flowchart of such a block reorganization process.

First, it is determined whether an input/output (I/O) for a logical address (A) is requested (Step S500). If the I/O is requested, a physical address (A′) recorded in a reorganization table is read (Step S502).

Then, it is determined whether the physical address (A′) is an initial value or not (Step S504). If the physical address is not the initial value, the corresponding block is inputted/outputted to/from the physical address (A′). If the physical address (A′) is found to be the initial value, on the other hand, it is determined whether the corresponding block is a reading operation (Step S508) or a writing operation (Step S510).

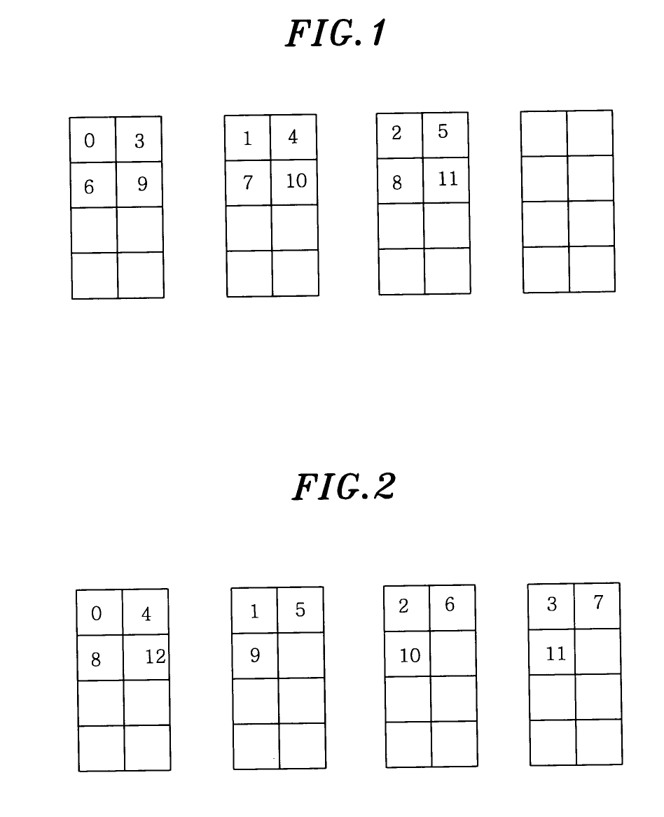

In accordance with the present invention, the reorganization process is conducted only for a block for which a write operation is requested by a user in case one disk is added to an initial disk state shown in FIG. 1. For example, if the user requests a write operation for a logical address No. 12 in an initial disk state illustrated in FIG. 1, the location of a block No. 12 after reorganization is calculated as follows.

12% 4=0 (remainder)

12/4=3 (quotient)

As shown in FIG. 3, the block No. 12 is located at a third block of a disk No. 0 after the reorganization process. Herein, the order of disks is defined as disk Nos. 0, 1, 2, 3 . . . from the left while the order of blocks in a disk is set to be block Nos. 0, 1, 2, 3 . . . from the upper left in a zigzag manner.

If the corresponding block is found to be the writing operation in the Step S510, a reorganization physical address (A′) of the logical address (A) is calculated (Step S511) and, then, it is determined whether the reorganization physical address (A′) exists in an added disk (Step S512).

If the disk number of the reorganization physical address (A′) for a block No. A is found to be a newly added disk number, the contents of the logical address (A) are stored in the newly added disk (Step S513).

Further, ‘F’ (‘F’ means that the reorganization process has not been performed) marked at the physical address of the block No. A on the reorganization table is updated as an actual physical address A′ (Step s514). At this time of updating the contents of the physical address A on the reorganization table, a lock function may be utilized for a multiple host service.

In other words, every time the reorganization table is updated, the lock function should be set and conducted and if the updating of the reorganization table is completed, the lock function is immediately released.

Referring back to the step S512, if the disk number of the reorganization physical address (a third block of the disk No. 0) of the requested block No. A (e.g., the block No. 12) corresponds to an existing disk, the newly determined physical address has been already occupied by another data so that the block (e.g., a block No. 9) which has been already stored in the reorganization physical address A′ should be moved to another position.

The reorganization process described above is sequentially performed. Since there exists a possibility that the system may be re-booted during the reorganization process, the contents of the requested block No. A should be safely stored in the disk until the sequential reaction reorganization process is terminated.

Thus, the contents of the block No. A are stored in a lower address part (A″) of the newly added disk (Step S515).

At this time, a free space manager manages free space in the newly added disk in order to store the block for which the write operation is requested from an end portion of the newly added disk.

If the block No. A has been safely stored, the block No. A on the reorganization table is locked. After the physical address is updated to be A″, the locking of the block A is released (Step S516).

After the operation on the block No. A (the block No. 12) is ended, blocks (block Nos. 9 and 7) in the chain reaction are also undergone through the chain reaction reorganization process so that they are placed in the newly added disk. Since the requested block is the block No. 12 in the preferred embodiment of the present invention, the block No. 7 (a block No. B) is stored in the new disk.

Therefore, the reorganization location B′ (a physical block No. 1 of a disk No. 3) of a final block (the block No. B) is calculated (Step S517) and the contents of the block No. B (the block No. 7) are moved thereto (Step S518).

The location of the block No. 7 on the reorganization table is updated by using the lock function (Step S519).

If the final block in the chain reaction is reorganized, then, a reorganization operation is performed for each block in a reverse order. The reorganization operations are performed until the requested block (A) is subjected to the operation.

To be more specific, the block No. 9 is determined to be located at a position where the block No. 7 is originally placed (a block No. 2 of a disk No. 1) after the reorganization process (Step S520).

Thus, the contents of the block No. 9 are moved to the physical block No. 2 of the disk No. 1 (Step S522) and the location of the block No. 9 on the reorganization table is updated by employing the lock function (Step S523).

The logical block No. 12 is moved to the location (the physical block No. 3 of the disk No. 0) originally occupied by the block No. 9. The block No. 12 is the block requested by the user and the contents thereof are stored in the end portion of the newly added disk while the address thereof is defined as A″.

Accordingly, the contents of the physical block No. A (the block No. 12) stored in A″ are moved to the block No. 3 of the disk No. 0 (Step S525) and the physical address on the reorganization table is changed from A″ to (0,3) (Step S526).

The changed locations of the blocks for which the reorganization operations have been conducted are stored in the reorganization table. Further, by checking whether a value on the reorganization table is in an initial state or not, it can be determined whether a given block has undergone the reorganization process or not.

If the value on the reorganization table is not the initial value, the given block has been reorganized. Accordingly, if the write operation is requested for a certain block, the process for deciding whether the block has been reorganized or not should be first performed. If the block has not been reorganized, an additional operation for moving relevant blocks to right positions is required. If the block has been reorganized previously, however, a disk I/O is conducted by using location information stored in the reorganization table.

A read operation is also performed by referring to the reorganization table. In other words, if the reorganization table is initialized, the disk I/O is performed by utilizing original location information while if the reorganization table is not in the initial state, the disk I/O is conducted by using location information on the reorganization table.

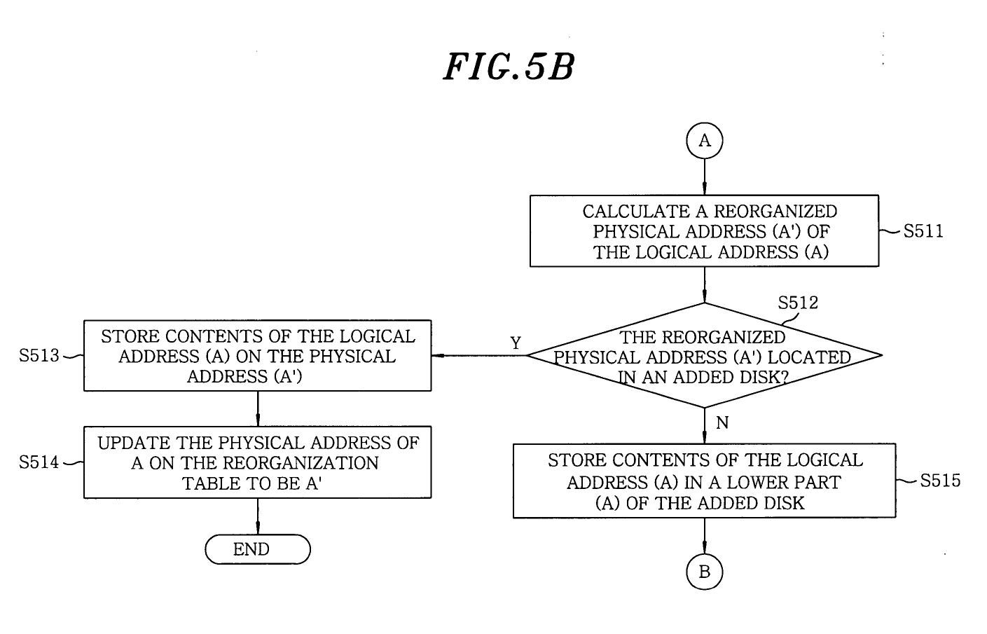

FIG. 4 illustrates values on the reorganization table after the block reorganization for the logical block No. 12 is terminated. In FIG. 4, the first number in a parenthesis refers to a disk number and the second number therein represents a physical address number. The reference ‘F’ stands for an initial state.

By setting the lock function for every change in the reorganization table, access from multiple users can be allowed.

If the reorganization process described above is completed, the reorganization table shown in FIG. 4 is initialized. Such an initialization process can be conducted at a time when partial reorganization is begun after a disk is added.

While the invention has been shown and described with respect to the preferred embodiments, it will be understood by those skilled in the art that various changes and modifications may be made without departing from the spirit and scope of the invention as defined in the following claims.

What is claimed is:

1. A data reorganization method in a RAID system using a striping technique comprising the steps of:
(a) determining whether an additional disk exists in a storage medium of the system;
(b) checking whether there exists any data stored at a reorganization-requested location for a disk write operation if there exists the additional disk; and
(c) moving a reorganization-requested data to the reorganization request location if there is no data stored in the reorganization-requested location.

2. The method of claim 1, wherein if it is determined in the step (b) that there is data stored in the reorganization-requested location, a requested disk write operation block is stored in sequence in the added disk starting from an end portion thereof and wherein the method further comprises the step of updating the physical information stored in the added disk to the requested block information of the reorganization table.

3. The method of claim 1, further comprising the steps of:
repeatedly calculating write blocks in a chain reaction affected by the requested block after the updating process is completed and investigating a block which has undergone the chain reaction reorganization process;
moving the investigated block to the added disk and reflecting physical information for the movement to the reorganization table; and
calculating a block to be moved to an original location of the block stored in the added disk, moving the calculated block to said location and reflecting physical information for the movement to the reorganization table.

4. The method of claim 3, wherein the block movement operation process is conducted until the reorganization of the requested write operation block is terminated.

5. The method of claim 1, wherein a lock function is utilized in case the reorganization table is modified in order to provide a multiple user service.

6. The method of claim 1, wherein the reorganization table is initialized for all the information stored in the disk after the step (c) is conducted or at an early time when a disk additional operation occurs.

7. The method of claim 2, wherein a free space manager manages free space in the added disk in order to store the block for which the write operation is requested from an end portion of the added disk.
